(19) United States
(12) Patent Application Publication
(10) Pub. No.: US 2008/0167879 A1
(43) Pub. Date: Jul. 10, 2008

(54) SPEECH DELIMITING PROCESSING SYSTEM AND METHOD

(76) Inventor: Denis D. Du Bois, Bothell, WA (US)

Correspondence Address: AXIOS LAW GROUP. PLLC, 1525 FOURTH AVENUE, SUITE 800, SEATTLE, WA, 98101, US

(21) Appl. No.: 11/873,382

(22) Filed: Oct. 16, 2007

Related U.S. Application Data
(60) Provisional application No. 60/829,635, filed on Oct. 16, 2006.

(51) Int. Cl. G10L 21/00

(52) U.S. Cl. 704/278; 704/E15.04

(57) ABSTRACT

A speech delimiting processing system and method are provided herein.

### RELATED REFERENCES

This application is based upon and claims the benefit of priority from Provisional Application No. 60/829,635 filed Oct. 16, 2006, the entire contents of which are incorporated herein by reference.

### BACKGROUND

Humans think of speech in words and phrases, not in minutes and seconds, nor in bits and bytes. Yet, when navigating and editing digital speech, computer users may be presented with a bit-oriented, visual, time-based method, not a more familiar auditory method.

Editing a digital recording of speech is often a complex task requiring specialized skills and software. Unlike digital text, which can be edited using any word processor, the spoken word is often stored and represented visually as a wave form. Editing a wave form using conventional tools may not be intuitive for many users.

Navigating within a speech recording also is cumbersome, even when the wave form is displayed. Often, however, a user recording their own speech is doing so without displaying a wave form. Examples are small digital voice recorders and telephone voice mail systems.

Currently available technologies for navigating and editing are based on two broad approaches:
(1) Time—the user's position in the wave form is indicated in minutes and seconds; a visual display represents bits and bytes along a timeline; editing involves adding or removing bytes. FIG. 1 is a screen snap of a common audio editing software program, Sound Forge, displaying a digitized speech recording 101 and highlighting one word (“podcast”) 102.
(2) Text—through speech recognition, the digital wave form of speech is converted by a computer into human-readable text; the visual display is text; editing involves adding or removing text, which does not affect the original audio. However, speech recognition technology may be error-prone.

In systems such as voice mail or handheld digital voice recorders, navigating around within a speech recording is based on time. It is an inefficient, trial-and-error process of moving to a specific time in the recording and hearing the spoken words in that portion of the recording. Editing is cumbersome to the extent that these systems offer the most basic of editing functions to the speaker, e.g., delete the entire message and re-record it.

In situations where the final product is a recording, the conversion of speech to text is not useful. Likewise, word processing will usually fail to produce the audio output desired, as the text is divorced from the sound in the earliest steps.

### BRIEF DESCRIPTION OF THE DRAWINGS

FIG. 1 is a screen snap shot of a common audio editing software program.

FIG. 2 is a speech network architecture diagram.

FIG. 3 is a conceptual illustration of a wave form of a recorded sentence.

FIG. 4 is a conceptual illustration of a wave form of a recorded question.

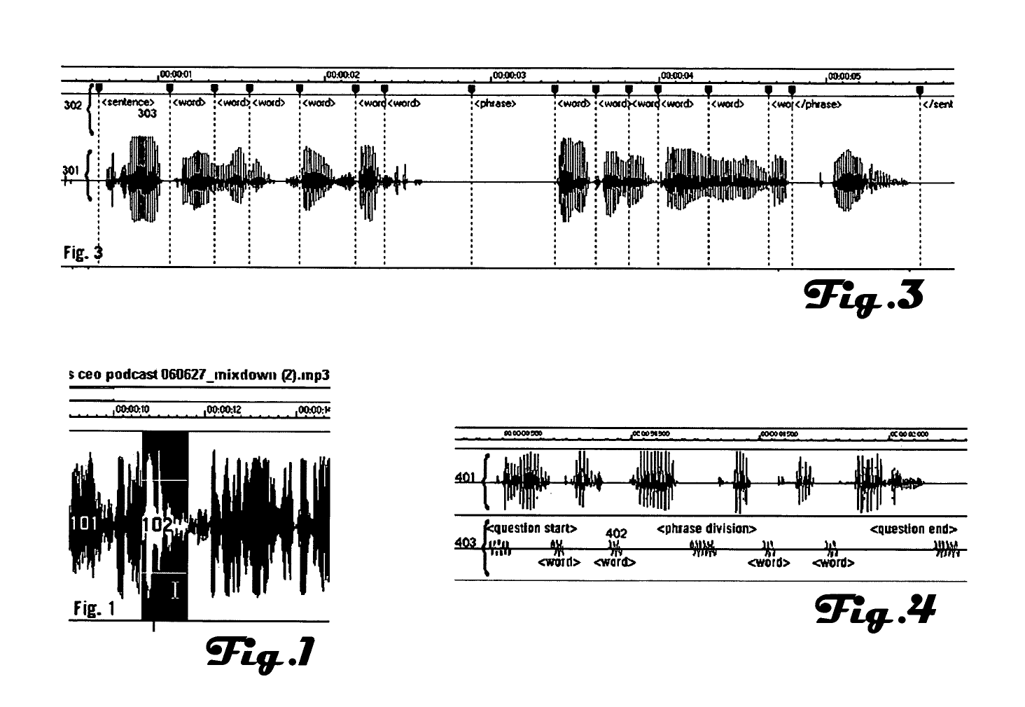

### DESCRIPTION

Although specific embodiments have been illustrated and described herein, it will be appreciated by those of ordinary skill in the art that a whole variety of alternate and/or equivalent implementations may be substituted for the specific embodiments shown and described without departing from the scope of the present invention. This application is intended to cover any adaptations or variations of the embodiments discussed herein.

Exemplary embodiments of a desirable voice recording editor may provide one or more abilities to:
Navigate within digital speech recordings using common parts of speech (e.g., by word, by sentence, by speaker), or using specialized parsing methods (e.g., by field of a form), or by searching for keywords or phrases.
Use language structure to provide context when searching within a recording.
Edit speech recordings without the need for a visual interface i.e., by using spoken commands or keyboard/keypad commands, instead of displaying a visual representation such as a wave form or text. This allows, for example, navigating and editing a speech recording by phone.
Automate editing of live speech, streamed speech playback, or speech recordings.

Navigating within speech recordings using language structure:

Provides the capability to find a specific portion or place in a recording by using commands such as “go back 1 sentence” or “go forward 3 words.” These commands may be issued using spoken commands, or using a keyboard, a computer mouse, a touch screen, or a keypad such as on a telephone, buttons on a digital voice recorder, or a purpose-built hardware device.

Finding and/or listening to portions of a speech recording would be possibly more efficient this way than by using time-based navigation, because the user would be able to skip back and forth through the recording by word, sentence, or other logical parts of speech, rather than by jumping in numbers of minutes or seconds to find the desired portion.

Searching within speech recordings using context:

A search for a keyword in a speech recording could be answered by playing back the sentence containing the sought word, or by simply playing the word and adding a few of the surrounding words for context. A search for multiple keywords could distinguish whether all sought words appear in the same sentence, possibly returning more accurately prioritized search results than if the distinction depended more simply on the words appearing within proximity of each other.

Example: A public company's quarterly analyst conference call is digitally recorded. In it the CEO speaks the following:
“We are looking for ways to bolster the price of our stock. Options include fraud and debauchery. We are also considering ways to delay the exercise of employee stock options.”

Immediately afterward, counsel speaks a search command into a computer-connected microphone: “find ‘stock options’ in this morning's analyst call.” With this embodiment, the computer's search function could distinguish between sentence 3 containing the words “stock options,” and two sentences 1 and 2, the first of which ends with “stock” and the second of which starts with “options.” The computer responds by playing back sentence 3:
“We are also considering ways to delay the exercise of employee stock options.”

Sentence 3, containing both keywords together, is played for the searcher first, even if it appears later chronologically in the recording than sentences 1 and 2, because it is deemed more likely to be relevant to the searcher.

Editing Speech Recordings Orally:

Provides the capability to add, replace, and delete portions of speech recordings by using commands based on the language structure of the spoken contents. These commands may be issued as described previously for navigation, with the potentially desirable ability to edit without a visual interface.

Example: A person dictating a contract by phone uses speech commands such as “cut the last 3 words,” “re-record that sentence,” or “insert a new recording” with the possibly more efficient result of sending to transcription a recording in which the incorrect and unwanted content has been reduced or removed.

Automated Self-Editing while Recording:

In some instances, using editing commands might not be necessary. A person recording their speech could re-record a sentence by starting again at its beginning; a system equipped with this embodiment could detect that the speaker is substantially repeating the previous sentence and replace the first recording with the corrected one.

Example: A person dictating a letter begins a sentence and makes a mistake, such as, “Peter Piper picked a peckled . . . ” The speaker stops and, without issuing editing commands, restarts the sentence correctly, “Peter Piper picked a peck of . . . ” The system detects the repetition and is programmed to act on the match by deleting the first sentence and keeping the second sentence.

A system equipped with this technology could detect and remove unwanted utterances, with or without a command or confirmation from the speaker. This form of editing has the potential benefits of shorter recordings without losing meaning, and of reducing listener distractions and thus communicating more effectively through recorded speech.

Example: A person recording a presentation habitually interjects the phrase “you know.” The system detects these utterances and removes them automatically, possibly in accordance with user settings for aggressiveness when matching and deleting these utterances.

Working with Specially Parsed Speech:

Provides the capability to use predetermined named parts of a speech recording when navigating and editing the recording. Those parts may be, for example, fields of a form, segments of a presentation, or speakers on a panel.

Retrieving information from the recording would be potentially more efficient than today's methods, because the listener could go directly to the desired part of the recording and retrieve only that part.

Example: A police incident report, digitally recorded using a handheld voice recorder, is parsed into discrete fields, such as the incident date, location, and eyewitness accounts. The report can be later navigated, e.g., “play the victim's description of the perpetrator” and the report can be corrected and edited, e.g., “re-record the location: 123 Main Street.”

If the recording is converted to text using speech recognition technology, that technology can be programmed to use the parsing features of the speech recording, and to structure the resulting text document or database record accordingly.

Combinations of the above capabilities could create new capabilities in retrieving information from lengthy recordings, such as court proceedings, legislative debate, broadcast, or live events.

Example: A panel of experts discusses for one hour the potential for a new energy source. The recorded discussion is parsed to separate the statements of each panelist. The recording can later be navigated, e.g., “play Dr. John Doe's comment about environmental side effects.” This example combines special parsing (based on recognizing the voices of each speaker) with searching and delimiting.

An example embodiment would be a speech editor software function. In one example implementation such an embodiment is implemented via software as an extension of the Eclipse Voice Tools Project for speech recognition and synthesis.
“Eclipse is an open source community whose projects are focused on providing an extensible development platform and application frameworks for building software. The Voice Tools Project (VTP) builds the ability to create speech recognition applications . . . . Based on industry standard markups like VoiceXML and SRGS, it features tools to help end users build dynamic applications using the web programming model. It also features [application programming interfaces (APIs)] to help tooling vendors extend the VTP to build compelling voice tools . . . . Although the Eclipse Platform has a lot of built-in functionality, most of that functionality is very generic. It takes additional tools to extend the Platform to work with new content types, to do new things with existing content types, and to focus the generic functionality on something specific.”

In such an approach, an embodiment would take the form of plug-in software modules using the VTP API and other common means to integrate the modules with existing speech recognition technology. Details of how to work with a VTP API are available online at Eclipse.org.

Server Hardware and Software:

Example software modules may run on a commonly available hardware platform and operating system, such as a current Windows server, IBM WebSphere Application Server, or Linux server. Windows or Linux could be equipped with Apache Tomcat server software (a requirement of Eclipse).

Recording and speech recognition are processor-intensive functions and, for high-demand applications, it may be beneficial to perform them on a dedicated computer hardware and software platform such as IBM's WebSphere Voice Server. Special applications, such as mobile audio devices or high-throughput real-time studio equipment, could be performed using a purpose-built hardware appliance or chip. In this example the hardware and software shall be referred to as the “editor server.”

If the source of the audio to be processed—audio input (such as a microphone) or storage device (such as a hard-disk drive)—are not contained within this editor server, then it is desirable to have a connection between the editor server and an audio input or storage device.

A basic example is to connect a microphone to the editor server and store the recordings on a hard disk drive in the editor server.

Another possible approach is to record via telephone. In this approach the editor server is connected to a private branch exchange (PBX) or other telephony device such as a switch that provides telephone connectivity. The PBX could be enabled to communicate with the editor server directly, or over a local area network (LAN), or over Internet protocol (IP), or a gateway device could be installed that provides translation of protocols and allows the PBX or telephony device to communicate with the editor server, or the editor server could be integrated into the PBX or telephony device.

Additional functionality, such as maintaining a database of recordings, could be developed using an interactive voice response (IVR) server, such as AVST or Genesys, and an industry-standard database, such as Oracle or Microsoft SQL.

Using the telephone-recording approach described above, the user will record and edit their speech recordings using a telephone. The user might dial into the PBX and follow voice prompts to connect with an instance of the speech editor. The user's session with the speech editor continues until terminated, for example, the user issues a command or hangs up to disconnect the call and end the session.

The modules in this exemplary embodiment may allow the user and/or system to perform specific functions described previously:
Navigating within speech recordings using language structure
Searching within speech recordings using context
Editing speech recordings aurally
Automated self-editing while recording
Working with specially parsed speech

These functions may depend on certain capabilities that are provided by the plug-in modules described in the earlier example. For example, navigating within speech recordings using language structure requires functionality to delimit speech based on language structure.

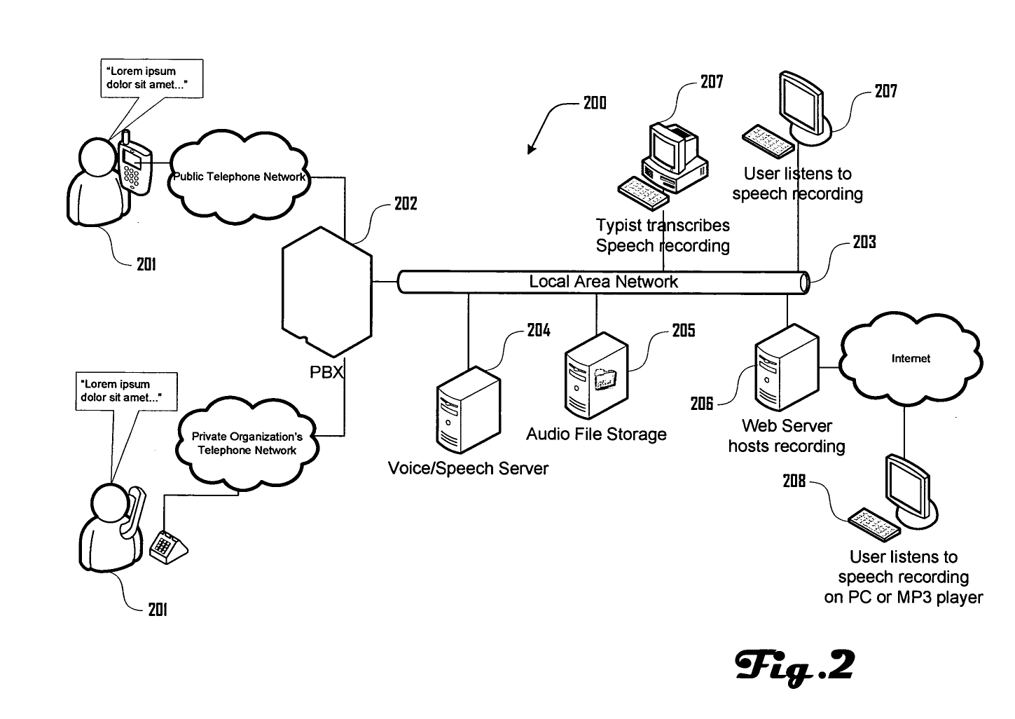

Speech Network Architecture 200 Diagram (Explanation of FIG. 2)

In one example implementation illustrated in FIG. 2, user 201 connects by telephone to the PBX (private branch exchange) phone switch 202 inside the organization. The originating telephone can be either inside the organization using an in-house phone network, or outside the organization using a public telephone network. The type of phone (analog, digital, cellular) makes no difference.

The PBX 202 is connected to the organization's LAN 203. Also connected to the LAN is an industry-standard data server or specialized voice/speech server 204, housing the software modules you are developing.

As the user records their speech through the phone system, the software modules on the voice/speech server process the speech and store it on an ordinary LAN-connected file storage server 205 and/or a Web server 206.

The stored speech file can be retrieved by other users 207 on the LAN, for purposes such as transcription. The file can be served across the Web for internet users 208 to download and hear.

Delimiting Speech Recording:

Various embodiments may establish or adopt a set of delimiter codes to be used to divide parts of recorded speech. These delimiters could be structured such that they could optionally contain extended data, such as identifying labels and keywords.

These delimiters may be stored within the audio recording by using a channel or track within the audio data stream, which channel or track would become the repository for delimiters.

Extensible Markup Language (XML) is one approach to creating these delimiters and structuring documents containing them. XML is commonly used to delimit and organize text data. This exemplary embodiment applies XML, or a similar structure, to delimit digital audio data. The XML delimiters are stored as text, while the audio can remain in its original digital format.

The editor software may create delimiters during recording, although it also may monitor a live audio stream, or operate on raw playback if post-processing a recording. The editor software may be invoked when these events (live speech, recording, or playback) occur.

Delimiters could separate common parts of speech, i.e., sentences, questions, phrases, and discrete words. An example embodiment could use conventional speech recognition to identify the fundamental language structure. Currently available speaker-independent speech recognition, even if only marginally accurate, is capable of identifying most major parts of speech, such as full stops at ends of sentences, question inflection, and pauses between phrases. An example embodiment could employ more advanced speech recognition, as needed and available, to improve recognition of fundamental language structures, such as discrete words, lists, or scientific terms.

The software may place delimiters into a selected channel, marking each part of the recorded speech. It could save the recording in an audio file format, such as WAV or MP3, which may be modified to carry the additional delimiter data channel or track.

FIG. 3 is a conceptual illustration of a wave form of a recorded sentence 301, delimited using an XML-like structures 302 to delimit parsed words, phrases, and sentences. In this example, each delimiter 303 is saved as a marker or region in a WAV file of the recording.

The delimiters could also be saved in a new channel, or as a separate file altogether and linked to the recording with timestamps.

FIG. 4 is a conceptual illustration of a wave form of a recorded question stored in the left channel 401 of a stereo recording, delimited using audio codes 402 stored in the right channel 403 of the recording. The delimiters are simple sequences of unique tones, labeled in this illustration for clarity. Delimiters could be stored in a newly created channel, instead of using one of the existing audio channels.

Navigating and Editing Via Spoken User Commands:

Once the recording is delimited, the editor software may allow the user to issue spoken commands that change the current position within the recording (navigation) and that change the recording (editing).

The editor software may support navigation by searching, or by moving forward or backward by parts of speech.

To accomplish editing and navigation by speech, it may be desirable to define or adopt a grammar set that includes command words, for example:
find
back (up)
(go) forward
(re)play sentence
delete (number) (words, phrases, sentences)
insert (before/after) (this) (word, phrase, sentence)
etc.

This embodiment may be incorporated with a speech interface wherein these commands can be spoken by the user, and the editor software responds by navigating to the selected part of the recording and/or inserting or removing audio as instructed.

The software may support natural-language commands such as these:
“Play the answer to the question about ‘stock options.’”
“Back up to the phrase containing ‘debauchery.’”
“What did Dr. Doe say about environmental side effects?”

Editing Via Automated Filters:

Editing filters are a set of patterns and corresponding instructions. Filtering may be a function of this embodiment that is triggered by a match between the recording and a pattern, followed by the execution of the instructions.

For example, the following would be a valid set of filters:

TABLE 1

| Part of speech | Pattern | Instruction |
|---|---|---|
| word | Uh | delete |
| word | Um | replace with silence of |
| | | same length |
| phrase | you know | delete |
| word | expletive | replace with beep of same |
| | | length |

It may be desirable to define or adopt a pattern-matching syntax similar to Windows wildcard characters (e.g., “*” means any group of syllables, “?” means any single syllable) or the Regular Expressions used in UNIX (e.g., “.” represents one syllable, “.*” represents any group of syllables). Establish a set of instructions (“delete,” “beep,” “mute,” etc.).

An example of this embodiment may incorporate a programmatic process to monitor the audio stream, convert the speech to text as accurately as is reasonable, match patterns using the syntax, and execute instructions to edit the audio output.

Specialized Delimiters:

In addition to parsing parts of speech, this embodiment could include the ability to use delimiters to separate any spoken information into its logical parts, as in filling in a form. This may involve establishing another set of delimiter codes, such as the fields of a form. For each delimiter code, it may be desirable to establish a set of one or more associated identification clues, such as keywords.

For example, a form field with a database schema field name of “location” uses certain keywords as clues that indicate that the field's data is being spoken. Those keywords might include “at,” “address,” “intersection,” “street,” etc. The context of the keyword would further help to identify the form field to use, e.g., “at 1230 First Street” is recognized an address field, whereas “at 12:30 today” is recognized as a time and date field.

Confidence Scores for Clue Matching:

Each clue could optionally include a numeric score which represents the incremental confidence provided by a specific match in the speech recording. The presence of multiple clues could increase the confidence score for delimiting that piece of audio as a specific field. For example, the words “twelve thirty” could be a time, date, street address, or none of these. The words “before twelve thirty today” offer additional clues: “before” probably eliminates this utterance as an address; “today” increases confidence that it is a time and date.

An example of this embodiment could use any available capabilities of current speech recognition technology to measure and track the confidence of each match. For example, if speech recognition technology is capable of using inflection or the context of surrounding words to improve its confidence in the recognition and meaning of a word or phrase, then this example could leverage these capabilities and increment the confidence score for each match. Low confidence thresholds may be set to cause the system to request that the user confirm or re-record information.

Creating and storing specialized delimiters:

These delimiters may be structured and implemented similarly to those used in the preceding description, adding the clues that may be used to help recognize and delimit the parts.

An example of this embodiment would create a channel or track within the audio data stream, which channel or track is to be used as the repository for delimiters. The speech editor would then monitor the input stream while recording, or monitor the raw audio stream if post-processing a recording.

It may be desirable to use conventional speech recognition to identify words within the speech. In this example the speech editor would compare the speech with the clues in the set of delimiter codes. When a match occurs, the speech editor would place a provisional delimiter into the selected channel, and increment the confidence score for the match.

Working with Specially Delimited Speech:

This embodiment may be implemented as a component of purpose-built software applications, such as insurance claims processing or police report filing software. It may use currently available capabilities of speech recognition technology and an IVR system to convert audio data to text data and then store it, possibly together with the audio data, in a database. It may use IVR or a similar interface to retrieve the data on demand and either display the text data, play the audio data, or read the text data as audio using synthesized speech.

### ALTERNATE EMBODIMENTS

In an alternate embodiment, one or more channels may be used for audio and one or more other channels may be used for delimiter data. This may require that the playback software convert the audio channel or channels to a reduced number of channels. Optionally the audio could be output without the data, for use in non-compatible software. As a result, the audio recording could be used with any common playback software, without concern over interference by the delimiter data.

In another alternate embodiment, the software may employ inaudible-frequency sound as codes, layered onto the audio recording without a separate track or channel. The frequency makes the delimiter codes inaudible to humans. This approach has the possible advantage of making it unnecessary to use special playback software or to output an additional copy of the audio without the delimiter data.

In still another alternate embodiment, the software may interlace delimiters within the wave form coding technique, such as Pulse Code Modulation (PCM), or using audio phase techniques. If the codes are audible, then the playback software could be programmed to omit those sounds.

In one example above, the embodiment used a telephone to record and speech and then used telephone-compatible commands to navigate and edit the speech recording. A telephone is not necessary for this embodiment. In an alternate embodiment, the user could use a microphone on a PC, rather than a telephone connection. Any recording technique that is commonly available has the potential advantage of added convenience and access from multiple locations and devices.

In a further alternate embodiment, a device such as a PC could run all of the speech recording software, including the speech navigation and speech editing functionality of this embodiment. This has the possible benefit of not requiring separate server hardware and network connections.

In a still further alternate embodiment, the user may record using a digital voice recorder and play back the audio to the system for analysis later. This has the potential advantage of allowing recording anyplace, without the need for connectivity to a separate speech server. This example could also allow the user to issue commands while recording, and those commands could be executed later on the speech server.

In yet a further alternate embodiment, a device such as a digital voice recorder or cell phone could have the functionality of this embodiment built into its software or firmware. This has the potential advantage of enabling a user to record, navigate, and edit a speech recording, without the need for real-time connectivity to a separate speech server, thereby completing the speech recording on a single device. The recording could later be transferred to a central server for other users to access and listen to it; or the audio could be accessed by other users directly from the device, e.g., if the cell phone acts as a Web server.

In yet another alternate embodiment, the user could record audio using a wireless communications device (such as a cell phone), storing the recording in the device's memory, and transmitting it to a server as a background task. This has the potential benefit of convenience by recording (and possibly editing) speech on a self-contained device, plus the possible advantage of using a wireless network's idle bandwidth to reduce the cost or resource load in the transfer of audio files to a central server.

Although specific embodiments have been illustrated and described herein, it will be appreciated by those of ordinary skill in the art that a whole variety of alternate and/or equivalent implementations may be substituted for the specific embodiments shown and described without departing from the scope of the present invention. This application is intended to cover any adaptations or variations of the embodiments discussed herein.

1. A speech delimiting processing system and method as shown and described.
